(19) United States
(12) Patent Application Publication
(10) Pub. No.: US 2007/0107672 A1
(43) Pub. Date: May 17, 2007

(54) 360º Multi-directional view canine harness

(76) Inventor: Baroness Von Czenkow, Charlotte, NC (US)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/544,281

(22) Filed: Oct. 6, 2006

Related U.S. Application Data
(60) Provisional application No. 60/725,094, filed on Oct. 11, 2005.

(51) Int. Cl. A01K 29/00; A01K 27/00

(52) U.S. Cl. 119/859

(57) ABSTRACT

A 360° multi-directional long distance lighted safety harness for a canine provides maximum visibility of a canine within approximately half mile radius. This is achieved by two battery operated multi-LED light units secured to a canine harness so that when the harness is positioned on the canine, one light unit is positioned on one side of the canine and the other light unit is positioned on the opposite side of the canine. When positioned, the light units protrude from the body of the canine.

### RELATED APPLICATION

This application claims priority in U.S. provisional application Ser. No. 60/725,094, filed Oct. 11, 2005.

### BACKGROUND OF THE INVENTION

1. Field of the Invention

The present invention relates to a canine harness. More particularly, the present invention relates to a maximum safety canine harness that provides a 360°, multi-directional, high visibility, trackable, light. Even more particularly, the present invention relates to a canine harness that enables a canine to be tracked by helicopter, search and rescue in open water, walked safely on rural roads and city street traffic by insuring high visibility to all traffic, as well as visibility in bad weather. It is envisioned that each light contains a silent tracking signal device enhancing search and rescue options.

2. Description of the Related Art

Collars and harnesses for canines, such as a dog, are well known. A harness is not the same as a collar. In particular, a collar goes around one limb or body part of a canine, whereas a harness goes entirely around the torso of the canine. The harnesses are designed for a variety of uses such as guide-services dogs, pets, sport, ski, search, and rescue, and carriage. It is well known that poor visibility is a serious traffic hazard. Unfortunately, known reflective collars and harnesses require another light source to function, and still have significant limitations. LED tube collars fail to outline the size of the dog, forcing a driver to have to guess at the distance required to avoid hitting the dog and its handler. The uni-directional collar light can only be seen in certain very limited circumstances. Thus, no lighted collars, heretofore, offer enough warning time, and are useless in extreme emergencies.

Citizens world wide now recognize a red strobe flashing light as “danger” and stop for it. Such lights on the harness can be seen for just under ½ mile or approximately 2,000 feet. However, the use of such lights have heretofore not been known in association with a canine.

### SUMMARY OF THE INVENTION

The present invention provides a canine harness that clearly outlines with light the bulk and body mass of the canine.

The present invention also provides a canine harness that instantly alerts traffic in all directions that there is a “caution” situation.

The present invention further provides a canine harness with light that can be seen approximately 2,000 feet.

The present invention still further provides a canine harness with light that can be seen approximately 2,000 feet above, under, front, behind, on the left and on the right of the canine wearing the light.

The present invention even further provides a canine harness with light that all of the lights are fully adjustable in number and position to conform to the particular dog's comfort, condition, and purpose.

The present invention yet further provides that the light functions in water, as well as in freezing temperatures.

The present invention also provides for the lighted canine harness to have a silent location or tracking signal that provides for rescue.

These and other advantages and benefits of the present invention are achieved by the 360° multi-directional, long distance lighted safety harness. The harness is comfortable for the dog or canine to wear.

### BRIEF DESCRIPTION OF THE DRAWINGS

FIG. 1 shows a dog having the harness of the present invention thereon, but with the lights in a horizontal position.

FIG. 2 shows a dog having the harness of the present invention thereon, but with the lights in a vertical position.

FIG. 3 is a front view of a dog having the harness of the present invention thereon.

FIG. 4 is a top view of the dog of FIG. 3.

FIG. 5 is front view of the light of the harness of the present invention.

FIG. 6 is a back view of the light of FIG. 5.

FIG. 7 is a schematic of the body of the light of FIG. 5.

### DETAILED DESCRIPTION OF THE PREFERRED EMBODIMENTS

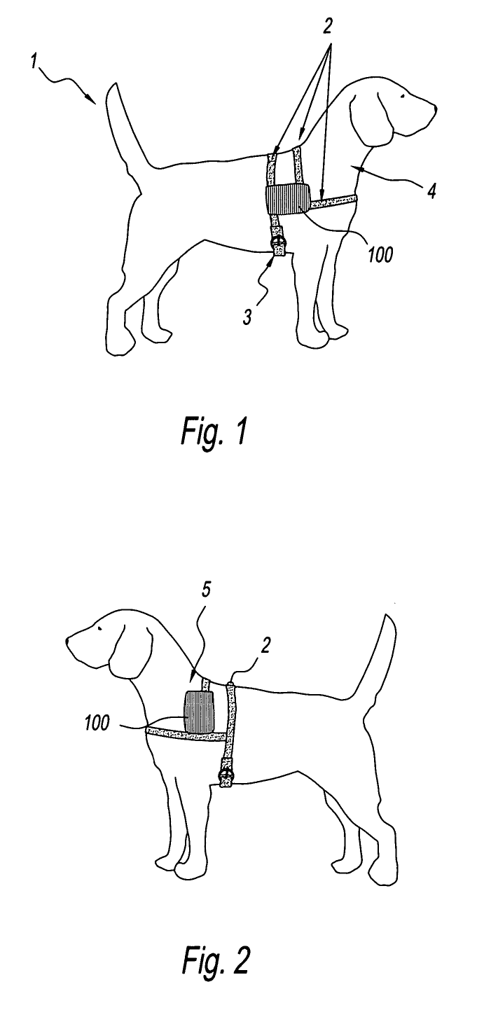

Referring to the drawings and, in particular, FIG. 1, a harness according to the present invention is generally represented by reference numeral 2. The harness 2 is sized to correctly fit to a canine, such as a dog 1. Thus, the harness 2 can be made in a variety of widths and sizes, and a variety of comfortable materials, such as nylon or leather, that have been tested and found comfortable to the canine.

The width and size of harness 2 is fitted for the canine 1. Fitting consists of measuring the girth or rib cage of the canine 1 at its fullest point adding two inches so that the harness 2 is secure yet loose. As the harness 2 is individually fitted to size and breed requirement, and can include modifications to X back, carting, and service harness.

Each strap of the harness 2 is sewn smooth to avoid “rubbing”. The width of each strap is appropriate to the breed size and weight, (for instance ⅝th inch, 1 inch) which is manufactured to create enough strength to support the canine working within it securely and without breaking. The girth strap 3 fastens by buckle comfortably.

Significantly, lights 100 are never placed on the girth strap 3 as it is a pressure strap that holds the harness in check, and thus could be uncomfortable to the canine. In the present harness 2, a light 100 is connected to the center connecting strap by slipping it onto the center strap firmly in place in horizontal position 4. Two lights 100 can be placed on the harness in this manner so that there is a light on the left and right side of the dog or canine.

There are always at least two lights 100 per harness 2, and can have as many as four lights on a working breed. The lights 100 can not slip as they are placed at a stop position on the harness 2. In horizontal position as shown in FIG. 1, the full weight of the light 100 is supported on the horizontal strap that prevents it from slipping.

The lights 100 on the harness 2 of the present invention can be seen for just under or approximately ½ mile or approximately 2,000 feet. The ½ mile or 2,000 feet visibility can be above, below, on the sides and in front of the canine once the harness is in its operative condition. For example, a driver behind or in front or to the left flank or to the right flank of the canine 1, can see the canine just under ½ mile or approximately 2,000 feet away, and thus can instantly recognize the canine and start to adjust speed and distance in response. Likewise, a helicopter flying 500 feet to 2,000 feet in the area, or a searcher under a bridge looking up, can see the canine 1 just under a ½ mile or approximately 2,000 feet away. Thus, the present harness 2 creates a full 360° visibility.

The lights 100 operate on long lasting AAA batteries 16 shown in FIG. 7. The batteries 16 last about 100 hours if the lights are running continuously or steady running. The batteries will last longer, perhaps 150 hours, if the lights operate in a flashing or strobe mode. The batteries will last between about 100 hours and 150 hours if the lights 100 operate in a combination of both modes. The harness 2 with lights 100 are worn during work or exercise. The bright, preferably red, lights, and more preferably flashing lights, in an emergency provides time for search and rescue should the canine or dog 1 and handler go missing or are caught in inclement weather, or stranded on a boat, or in car.

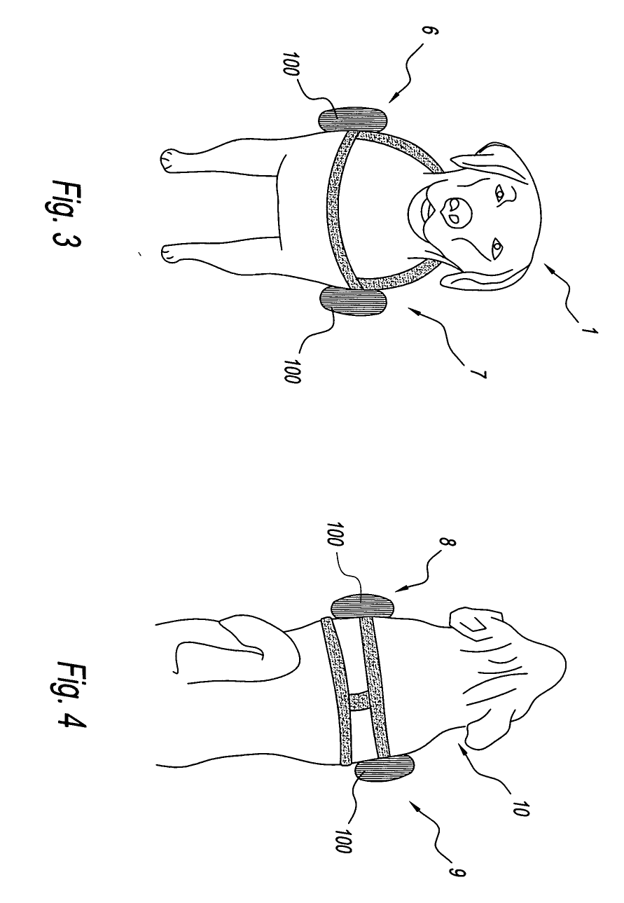

Referring to FIG. 2, the dog 1 has a harness 2 of the present invention with the lights 100 in the vertical position 5, which is more comfortable in some breeds of canine. In this embodiment, a pair of lights 100 are positioned with one light on the left side 7 and one light of the right side 6 of the harness 2 as shown in FIG. 3. The stop position in the vertical occurs at the 90° angle of the vertical and horizontal straps and holds the light securely in position.

As shown in FIG. 3, the lights 100 protrude beyond the body of the canine 1. The top portion 19 of each light 100 provides at least 180° of lighting in all directions. Thus, the light 100 on the left side 6 and the light on the right side 7 each provide 180° in all directions and by their positioning provides an important feature, namely the two protruding lights allows for 360° viewing. Thus, the dog 1 can be seen from in front, behind, above, and below.

FIG. 4 shows an overhead view of the canine 1 with the harness 2 in position. As shown clearly, the protrusion of the lights 100, shown as 8 on the left and 9 on the right of dog 1, provides for overhead visibility, such as from a helicopter. Thus, search and rescue, law enforcement, military, and specialized training, whether helicopter or under a bridge, floor board, can be viewed and sighted.

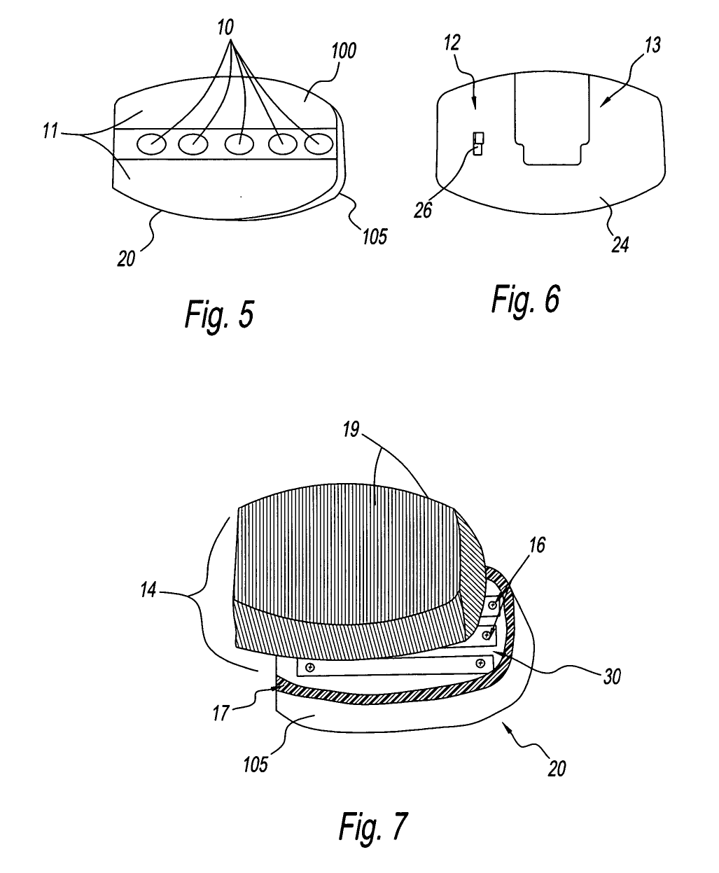

FIG. 5 shows an inside surface of the bottom portion 20 of the body 105 of the light 100. This light 100 is also set forth in co-pending application titled Safety Lights for Connection to People, which has the same inventors, and is filed on even date with this application. That application claims priority in U.S. provisional application Ser. No. 60/725,095 filed on Oct. 11, 2005. This co-pending application is incorporated herein by reference with respect to the entire light 100 and the belt clip therefore. The inside surface of light 100 is primarily a metallic reflective surface or liner 11 upon which or through which or around which the LEDs are positioned. The high visibility lights are further enhanced by using the magnification metallic surface or liners 11 in each light unit.

The light 100 is two or more lights 10. Preferably, each light 10 is an LED. More preferably, there are at least three to seven LEDs, and they are positioned in a row. More preferably, the number of LEDs is three or five or seven. Most preferably, there are five LEDs. However, the number of LEDs 10 is not limited to a precise number, and the LEDs can be in an amount that run the length of the light 100. Again, the LEDs 10 are preferably in a row, however that can possible be in a random pattern, but spaced from each other.

The one or more LEDs 10 are preferably positioned in the center of the reflective surface 11. In the embodiment shown in FIG. 5, the reflective surface 11 is the core or surface of the light 100 and the LEDs 10, preferably five, are separated but surrounded by the surface so that the LEDs have a better reflective effect. In every embodiment, it is preferred that there is some reflective surface 11 between each adjacent pair of LEDs 10 and surface 11 beyond the last LED 10 in a row. Also, preferably the number of LEDs is an odd number, with five being most preferred as shown in FIG. 5.

The LEDs 10 last 100 hours if set on the “continuous” setting and 150 hours if set on the “flashing” setting. The flash setting provides a strobe light. Clearly, each LED 10 lasts between 100 to 150 hours if the settings vary between continuous and flashing. It is found that each light 100 can be seen for about ½ mile or about 2,000 feet.

Referring to FIG. 6, the back 24 of the light 100 preferably has an “on and off” button 26 to preserve the battery that powers the light 100. In the body, there is a controller or chip that when the button 26 is activated, activates the power source in one of two modes, namely a continuous or an intermittent or flashing mode. The controller or chip is conventionally known.

The back 24 of the light 100 may have a belt clip 13 that allows for the secure placement of the light on clothing. Preferably, the belt clip 13 is a clip on that will not damage clothing and yet provides a secure connection, and re-positioning of the lights 100 as needed.

Referring to FIG. 7, the light 100 has a body or case 105 that is preferably at least 2″×3″×2″ wide as shown by reference numeral 14. The body or case 105 that opens 30 to provide a compartment for one or more AAA batteries 16. Preferably, the batteries 16 last 150 hours before recharging or change of batteries. The body 105 has a rubber gasket 17 positioned between the top portion 19 and bottom portion 20 of the light body so that the LEDs and other components in the body are sealed airtight. Thus, the light 100 is waterproof and therefore it can float, as well as can be used in wet weather.

Preferably, the top and sides of the top portion 19 of the body 105 is red. However, the top and sides can be another bright color that denotes or indicates a warning, such as, for example, amber, blue, green or yellow. The bottom portion 20, which holds the batteries and LEDs, can be any color. However, the bottom portion preferably is a transparent smoke grey color.

It is envisioned that the airtight body 105 of each light 100 can have a silent location or tracking signal that provides for rescue of the wearer, namely the canine, and the canine's handler who may be traveling with the canine.

It is to be understood that the above examples are for illustrative purposes only. Variations to the specific embodiments described in the examples can be made and remain within the scope of the invention.

Wherefore, I claim:

1. A safety harness for a canine comprising:
a plurality of straps connected together to form a harness that comfortably fits on the canine;
at least two light sources for removable connection to the safety harness, at least one of the at least two light sources on one side of the canine and the other of the at least two light sources on the other, opposite side of the canine, each light source having a body for housing a plurality of LEDs and for receipt of a removable power source, each body when positioned on the canine protrudes from the body of the canine so that the at least two light sources on opposite sides of the canine provide 360 degrees light about the canine.

2. The safety harness of claim 1, wherein one of the at least two light sources when activated provides a bright light that can be seen for about ½ mile.

3. The safety harness of claim 1, wherein each one of the at least two light sources has a reflective surface upon which the plurality of LEDs are placed or pierce through.

4. The safety harness of claim 3, wherein the reflective surface reflects light from the plurality of LEDs.

5. The safety harness of claim 1, further comprising a controller so that the plurality of LEDs provide a continuous light.

6. The safety harness of claim 1, further comprising a controller so that the plurality of LEDs provide a flashing light.

7. The safety harness of claim 1, wherein the plurality of LEDs is five LEDs.

8. The safety harness of claim 7, wherein the five LEDs are positioned in a row and in the center of the body.

9. The safety harness of claim 1, wherein the plurality of LEDs is an odd number of LEDs from three to seven.

10. The safety harness of claim 1, wherein the body has a top portion and a bottom portion that are openable with respect to each other, and wherein the bottom portion of the body can hold the power source therein.

11. The safety harness of claim 1, wherein the body has a top portion that has a colored surface through which the plurality of LEDs emit light.

12. The safety harness of claim 11, wherein the colored surface is red so that the light emitted appears to be red.

13. The safety harness of claim 11, wherein the top portion protrudes beyond the body of the canine when positioned on the canine.

14. The safety harness of claim 11, wherein the body has a bottom portion that is positioned against the body of the canine.

15. The safety harness of claim 14, wherein the bottom portion is a transparent smoke grey color.

16. The safety harness of claim 1, wherein the at least two light sources is two light sources each positioned on a different side of the canine.

17. The safety harness of claim 16, wherein the two light sources each positioned on a different side of the canine each protrude beyond the body of the canine and emit light in 180 degrees in all directions when positioned on the canine.

18. The safety harness of claim 16, wherein the two light sources as positioned, provide 360 degrees of light about the canine.

19. The safety harness of claim 1, wherein each of the at least two light sources further comprises a belt clip.

20. The safety harness of claim 1, wherein each of the at least two light sources further comprises a silent location or tracking signal.
